(19) United States
(12) Patent Application Publication
(10) Pub. No.: US 2015/0286982 A1
(43) Pub. Date: Oct. 8, 2015

(54) DYNAMICALLY MODELING WORKLOADS, STAFFING REQUIREMENTS, AND RESOURCE REQUIREMENTS OF A SECURITY OPERATIONS CENTER

(71) Applicant: International Business Machines Corporation, Armonk, NY (US)

(72) Inventor: Paul J. Dwyer, Pewaukee, WI (US)

(73) Assignee: International Business Machines Corporation, Armonk, NY (US)

(21) Appl. No.: 14/246,543

(22) Filed: Apr. 7, 2014

(51) Int. Cl. G06Q 10/06

(52) U.S. Cl. CPC G06Q 10/063118; G06Q 10/067

(57) ABSTRACT

A method and associated systems for dynamically modeling workloads, staffing requirements, and resource requirements of a security operations center. A processor receives an average rate at which the center receives threats, an average time needed to handle a threat, a target time within which the center desires to respond to a threat, and a target service level that characterizes a goal of handling a certain portion of a workload within certain constraints. The processor develops a model of the operations center and allows the user to fine-tune the model by proposing what-if scenarios. The processor uses statistical methods that time-distribute characteristics of the workload and uses staff-availability information to translate the model into an interval capacity plan, which the user may further fine-tune by proposing additional scenarios. The processor continues to refine the model by comparing real-world results with the capacity plan's forecasts and by considering further user input.

### TECHNICAL FIELD

The present invention relates to determining a cost of operating a security operations center.

### BACKGROUND

Planning or operating a business function like a Security Operations Center may comprise modeling a future workload of the business function in order to better forecast staffing levels and other resources needed by the business function in order to provide a desired level of service.

This modeling may be complicated by a need to integrate multiple analyses performed by different business functions, to analyze and relate a variety of operational variables, and to account for frequency distributions of workload tasks. Such requirements may be problematic for a Security Operations Center, where peak workloads may be triggered suddenly by an unexpected security threat.

A specialized workload-modeling tool is thus needed for operations that, like a Security Operations Center, must be able to quickly detect and respond to unplanned extrinsic incidents.

### BRIEF SUMMARY

A first embodiment of the present invention provides a method for dynamically modeling workloads, staffing requirements, and resource requirements of a security operations center, the method comprising:

a processor of a computer system receiving an initial set of values of a set of parameters, wherein the set of parameters characterize a workload of the security operations center and a target level of service intended to be provided by the center, and wherein the workload comprises one or more tasks associated with resolving a set of incoming incidents;

the processor deriving a preliminary model of the security operations center as a function of the received values;

the processor communicating one or more characteristics of the preliminary model to a user;

the processor further receiving from the user a first updated value in response to the communicating;

the processor revising the preliminary model as a function of the first updated value;

the processor employing a statistical method to translate the revised preliminary model into a preliminary interval model that comprises a set of distribution curves, wherein a first curve of the set of distribution curves comprises a first set of probabilities associated with a first time interval of a set of time intervals, and wherein a first probability of the first set of probabilities identifies a probability that a first quantity of incoming incidents of the set of incoming incidents will be received by the security operations center during the first time interval;

the processor accessing staff-availability information;

the processor incorporating the staff-availability information into the preliminary interval model in order to produce a preliminary capacity plan that identifies resource requirements and staff requirements for each time interval of the set of time intervals;

the processor further communicating to the user the preliminary capacity plan as a user-editable preliminary resource-planning table;

the processor accepting from the user a second updated value, wherein the user has entered the second updated value by editing the preliminary resource-planning table;

the processor generating a refined capacity plan as a function of the accepting.

A second embodiment of the present invention provides a computer program product, comprising a computer-readable hardware storage device having a computer-readable program code stored therein, said program code configured to be executed by a processor of a computer system to implement a method for dynamically modeling workloads, staffing requirements, and resource requirements of a security operations center, the method comprising:

the processor receiving an initial set of values of a set of parameters, wherein the set of parameters characterize a workload of the security operations center and a target level of service intended to be provided by the center, and wherein the workload comprises one or more tasks associated with resolving a set of incoming incidents;

the processor deriving a preliminary model of the security operations center as a function of the received values;

the processor communicating one or more characteristics of the preliminary model to a user;

the processor further receiving from the user a first updated value in response to the communicating;

the processor revising the preliminary model as a function of the first updated value;

the processor employing a statistical method to translate the revised preliminary model into a preliminary interval model that comprises a set of distribution curves, wherein a first curve of the set of distribution curves comprises a first set of probabilities associated with a first time interval of a set of time intervals, and wherein a first probability of the first set of probabilities identifies a probability that a first quantity of incoming incidents of the set of incoming incidents will be received by the security operations center during the first time interval;

the processor accessing staff-availability information;

the processor incorporating the staff-availability information into the preliminary interval model in order to produce a preliminary capacity plan that identifies resource requirements and staff requirements for each time interval of the set of time intervals;

the processor further communicating to the user the preliminary capacity plan as a user-editable preliminary resource-planning table;

the processor accepting from the user a second updated value, wherein the user has entered the second updated value by editing the preliminary resource-planning table;

the processor generating a refined capacity plan as a function of the accepting.

A third embodiment of the present invention provides a computer system comprising a processor, a memory coupled to said processor, and a computer-readable hardware storage device coupled to said processor, said storage device containing program code configured to be run by said processor via the memory to implement a method for dynamically modeling workloads, staffing requirements, and resource requirements of a security operations center, said method comprising:

the processor receiving an initial set of values of a set of parameters, wherein the set of parameters characterize a workload of the security operations center and a target level of service intended to be provided by the center, and wherein the workload comprises one or more tasks associated with resolving a set of incoming incidents;

the processor deriving a preliminary model of the security operations center as a function of the received values;

the processor communicating one or more characteristics of the preliminary model to a user;

the processor further receiving from the user a first updated value in response to the communicating;

the processor revising the preliminary model as a function of the first updated value;

the processor employing a statistical method to translate the revised preliminary model into a preliminary interval model that comprises a set of distribution curves, wherein a first curve of the set of distribution curves comprises a first set of probabilities associated with a first time interval of a set of time intervals, and wherein a first probability of the first set of probabilities identifies a probability that a first quantity of incoming incidents of the set of incoming incidents will be received by the security operations center during the first time interval;

the processor accessing staff-availability information;

the processor incorporating the staff-availability information into the preliminary interval model in order to produce a preliminary capacity plan that identifies resource requirements and staff requirements for each time interval of the set of time intervals;

the processor further communicating to the user the preliminary capacity plan as a user-editable preliminary resource-planning table;

the processor accepting from the user a second updated value, wherein the user has entered the second updated value by editing the preliminary resource-planning table;

the processor generating a refined capacity plan as a function of the accepting.

### BRIEF DESCRIPTION OF THE DRAWINGS

FIG. 1 shows the structure of a computer system and computer program code that may be used to implement a method for dynamically modeling workloads, staffing requirements, and resource requirements of a security operations center in accordance with embodiments of the present invention.

FIG. 2 is a flow chart that shows a high-level view of an embodiment of the method of the present invention.

FIG. 3 is a flow chart that describes detailed steps of an embodiment of a method for dynamically modeling workloads, staffing requirements, and resource requirements of a security operations center (SOC) in accordance with embodiments of the present invention.

### DETAILED DESCRIPTION

Planning or operating a business function like a Security Operations Center (SOC) may comprise modeling the SOC's future workload in order to better forecast staffing levels and other resources needed by the SOC in order to provide a desired level of service.

This modeling may be especially difficult for a business function like an SOC, which must quickly detect and respond to unplanned extrinsic events that: i) are discrete (that is, a likelihood of a second event occurring, or occurring at a particular time, is not a function of a likelihood of a first event occurring or occurring at a particular time); ii) have a low probability of occurring (thus potentially being irregularly distributed in time); and iii) are persistent (do not resolve themselves if they are not serviced within a certain period of time).

In this document, we will, for the sake of illustration, refer to embodiments of the present invention that are implemented for a SOC that identifies, analyzes, and addresses security threats like computer malware or malicious cyberattacks. These references do not imply a constraint on the scope of the present invention to SOC business functions. Embodiments of the present invention may be associated with any business function that must respond to any type of events that are discrete, have a low probability of occurring, and are persistent.

Embodiments of the present invention may comprise a combination of novel methods and mathematical techniques and may comprise a novel combination of with methods and techniques known to those skilled in the art. Such embodiments may dynamically model working, staffing, and resource requirements of a SOC, as required to allow the SOC to provide a desired level of service. Embodiments of the present invention may vary considerably within these constraints, depending upon the specific needs and operational characteristics of the SOC.

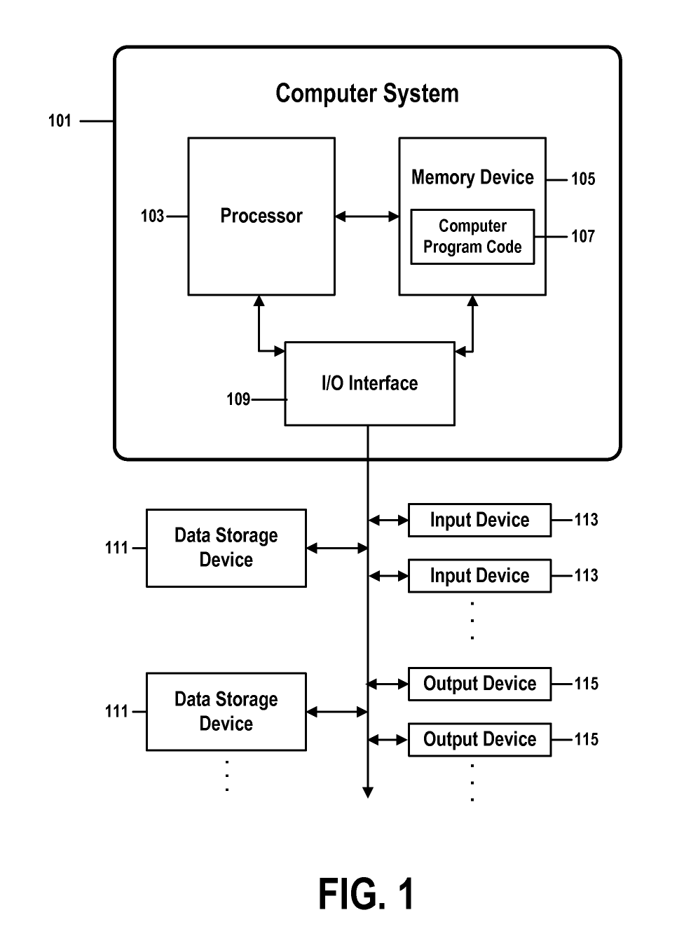

Embodiments described in FIGS. 1-3 may apply an Erlang C traffic-modeling formula, known to those skilled in the art, to estimate a first-pass model of an SOC's staffing requirements based on statistical data that describes characteristics of incoming threats or other types of incidents to which the SOC must respond.

These embodiments may further apply a Poisson probability-distribution statistical modeling technique, known to those skilled in the art, to identify a distribution in time of incoming incidents, where the incoming incidents arrive infrequently and at unpredictable or irregular times.

These embodiments may further comprise feedback mechanisms that fine-tune a workload model and capacity-planning plan by analyzing an accuracy of a capacity-planning plan previously generated by the embodiment. These embodiments may also allow a user to fine-tune a generated model and plan, as a function of the user's business knowledge or other expert knowledge, by interactively suggesting “what-if” scenarios.

This novel framework is intended to help a user perform real-time what-if analyses that may estimate a SOC's workloads, compare effects of different staffing plans upon SOC operating costs and desired service levels, forecast queue wait times, estimate backlogs and set work-in-progress targets, predict the SOC's throughput, and identify threat-handling cycle times.

Embodiments described herein may comprise other statistical models or forecasting methods, as appropriate to a particular implementation, such as methods of Activity-Based Costing. Embodiments described herein may further comprise a novel interactive user interface or novel non-interactive interface that comprises a combination of proprietary data-entry, reporting, feedback, or data-presentation features.

Embodiments of the present invention thus allow a user to quickly model an SOC's workload and identify an optimized capacity-planning strategy that balances costs and resource availability against desired staffing levels and service levels.

FIG. 1 shows a structure of a computer system and computer program code that may be used to implement a method for dynamically modeling workloads, staffing requirements, and resource requirements of a security operations center in accordance with embodiments of the present invention. FIG. 1 refers to objects 101-115.

Aspects of the present invention may take the form of an entirely hardware embodiment, an entirely software embodiment (including firmware, resident software, microcode, etc.) or an embodiment combining software and hardware aspects that may all generally be referred to herein as a “circuit,” “module,” or “system.”

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

In FIG. 1, computer system 101 comprises a processor 103 coupled through one or more I/O Interfaces 109 to one or more hardware data storage devices 111 and one or more I/O devices 113 and 115.

Hardware data storage devices 111 may include, but are not limited to, magnetic tape drives, fixed or removable hard disks, optical discs, storage-equipped mobile devices, and solid-state random-access or read-only storage devices. I/O devices may comprise, but are not limited to: input devices 113, such as keyboards, scanners, handheld telecommunications devices, touch-sensitive displays, tablets, biometric readers, joysticks, trackballs, or computer mice; and output devices 115, which may comprise, but are not limited to printers, plotters, tablets, mobile telephones, displays, or sound-producing devices. Data storage devices 111, input devices 113, and output devices 115 may be located either locally or at remote sites from which they are connected to I/O Interface 109 through a network interface.

Processor 103 may also be connected to one or more memory devices 105, which may include, but are not limited to, Dynamic RAM (DRAM), Static RAM (SRAM), Programmable Read-Only Memory (PROM), Field-Programmable Gate Arrays (FPGA), Secure Digital memory cards, SIM cards, or other types of memory devices.

At least one memory device 105 contains stored computer program code 107, which is a computer program that comprises computer-executable instructions. The stored computer program code includes a program that implements a method for dynamically modeling workloads, staffing requirements, and resource requirements of a security operations center in accordance with embodiments of the present invention, and may implement other embodiments described in this specification, including the methods illustrated in FIGS. 1-3. The data storage devices 111 may store the computer program code 107. Computer program code 107 stored in the storage devices 111 is configured to be executed by processor 103 via the memory devices 105. Processor 103 executes the stored computer program code 107.

Thus the present invention discloses a process for supporting computer infrastructure, integrating, hosting, maintaining, and deploying computer-readable code into the computer system 101, wherein the code in combination with the computer system 101 is capable of performing a method for dynamically modeling workloads, staffing requirements, and resource requirements of a security operations center.

Any of the components of the present invention could be created, integrated, hosted, maintained, deployed, managed, serviced, supported, etc. by a service provider who offers to facilitate a method for dynamically modeling workloads, staffing requirements, and resource requirements of a security operations center. Thus the present invention discloses a process for deploying or integrating computing infrastructure, comprising integrating computer-readable code into the computer system 101, wherein the code in combination with the computer system 101 is capable of performing a method for dynamically modeling workloads, staffing requirements, and resource requirements of a security operations center.

One or more data storage units 111 (or one or more additional memory devices not shown in FIG. 1) may be used as a computer-readable hardware storage device having a computer-readable program embodied therein and/or having other data stored therein, wherein the computer-readable program comprises stored computer program code 107. Generally, a computer program product (or, alternatively, an article of manufacture) of computer system 101 may comprise said computer-readable hardware storage device.

While it is understood that program code 107 for dynamically modeling workload, staffing, and resource requirements of a security operations center may be deployed by manually loading the program code 107 directly into client, server, and proxy computers (not shown) by loading the program code 107 into a computer-readable storage medium (e.g., computer data storage device 111), program code 107 may also be automatically or semi-automatically deployed into computer system 101 by sending program code 107 to a central server (e.g., computer system 101) or to a group of central servers. Program code 107 may then be downloaded into client computers (not shown) that will execute program code 107.

Alternatively, program code 107 may be sent directly to the client computer via e-mail. Program code 107 may then either be detached to a directory on the client computer or loaded into a directory on the client computer by an e-mail option that selects a program that detaches program code 107 into the directory.

Another alternative is to send program code 107 directly to a directory on the client computer hard drive. If proxy servers are configured, the process selects the proxy server code, determines on which computers to place the proxy servers' code, transmits the proxy server code, and then installs the proxy server code on the proxy computer. Program code 107 is then transmitted to the proxy server and stored on the proxy server.

In one embodiment, program code 107 for dynamically modeling workload, staffing, and resource requirements of a security operations center is integrated into a client, server and network environment by providing for program code 107 to coexist with software applications (not shown), operating systems (not shown) and network operating systems software (not shown) and then installing program code 107 on the clients and servers in the environment where program code 107 will function.

The first step of the aforementioned integration of code included in program code 107 is to identify any software on the clients and servers, including the network operating system (not shown), where program code 107 will be deployed that are required by program code 107 or that work in conjunction with program code 107. This identified software includes the network operating system, where the network operating system comprises software that enhances a basic operating system by adding networking features. Next, the software applications and version numbers are identified and compared to a list of software applications and correct version numbers that have been tested to work with program code 107. A software application that is missing or that does not match a correct version number is upgraded to the correct version.

A program instruction that passes parameters from program code 107 to a software application is checked to ensure that the instruction's parameter list matches a parameter list required by the program code 107. Conversely, a parameter passed by the software application to program code 107 is checked to ensure that the parameter matches a parameter required by program code 107. The client and server operating systems, including the network operating systems, are identified and compared to a list of operating systems, version numbers, and network software programs that have been tested to work with program code 107. An operating system, version number, or network software program that does not match an entry of the list of tested operating systems and version numbers is upgraded to the listed level on the client computers and upgraded to the listed level on the server computers.

After ensuring that the software, where program code 107 is to be deployed, is at a correct version level that has been tested to work with program code 107, the integration is completed by installing program code 107 on the clients and servers.

Embodiments of the present invention may be implemented as a method performed by a processor of a computer system, as a computer program product, as a computer system, or as a processor-performed process or service for supporting computer infrastructure.

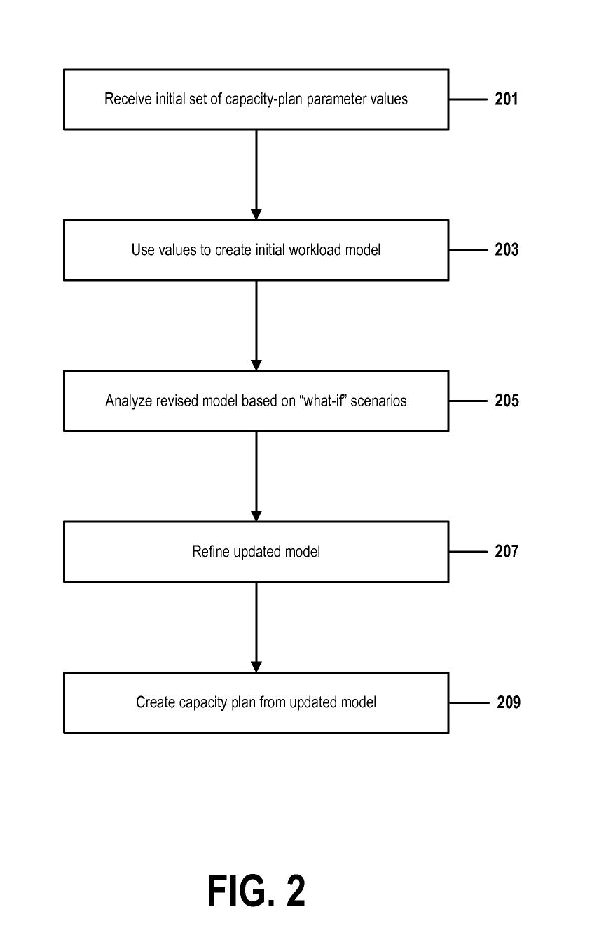

FIG. 2 is a flow chart that shows a high-level view of an embodiment of the method of the present invention. FIG. 2 comprises steps 201-209.

In step 201, a processor of a computer system receives a set of values of parameters that characterize an operation of an incident-handling business function such as a Security Operations Center (SOC). Such parameters might, for example, identify a quantity or frequency of incoming incidents (such as an SOC's detections of malware or other types of threats or potential threats) during a previous period of time. Such received information might further describe a goal of the SOC, such as a need to evaluate or otherwise address a certain per cent of incoming incidents within a target handling time. Such a need may be characterized as a “level of service,” or, more simply, as the SOC's “service level.”

In step 203, the processor generates an initial estimate of a model of the SOC's workload as a function of the information received in step 201, where that model allows the processor to identify staffing requirements and other resource requirements necessary to handle the workload.

Here, the processor communicates to a user information that may comprise a summary of or other aggregation of some or all of the information received in step 201, and further communicates to the user some or all of the information that the processor derives from that information in this step.

In step 205, the processor allows the user to vary some or all of the information communicated to the user in step 203, in order to allow the user to review and compare “what-if” scenarios that might occur should future values of the set of parameters vary from the values received in step 201.

In one example, information received in step 201 might identify a desired service level that comprises an ability to respond to 99.0% of all incoming threats within a ten-minute target response time. This information might have further allowed the processor in step 203 to forecast a likely incoming threat rate of 6.5 threats per half-hour and to forecast a staffing requirement of five analysts in order to achieve the desired service level when such an incoming threat rate exists.

In this example, the processor might then, in step 205, allow the user to evaluate other scenarios by manually revising some or all of the information received in step 201 or directly or indirectly inferred from information received in step 201. If, for example, the user redefines the SOC's desired service level by extending the target response time to 15 minutes, the processor might in step 205 determine and report that two analysts will be needed to maintain that level of service.

This iterative or prototyping process may continue interactively or noninteractively until the user is satisfied with the results of the user's proposed revisions. In each case, the processor may generate and report revised results as a result of revising the generated model to accommodate one set of the user's submitted revisions. Each such instance may represent one “what-if” scenario that is associated with one generated model of the SOC's operating conditions, resource or staffing requirements, workload, or combinations thereof.

In step 207, the processor selects a generated model from the one or more models generated in step 205, wherein each generated model is associated with a scenario inferred in step 203 or generated as a result of user input in step 205.

In step 209, the processor generates a capacity plan, including staffing requirements, based on the scenario or model chosen in step 207. This capacity plan may describe the resources, including personnel requirements, required in order for the SOC to achieve its desired level of service when handling a forecast likely incoming threat level.

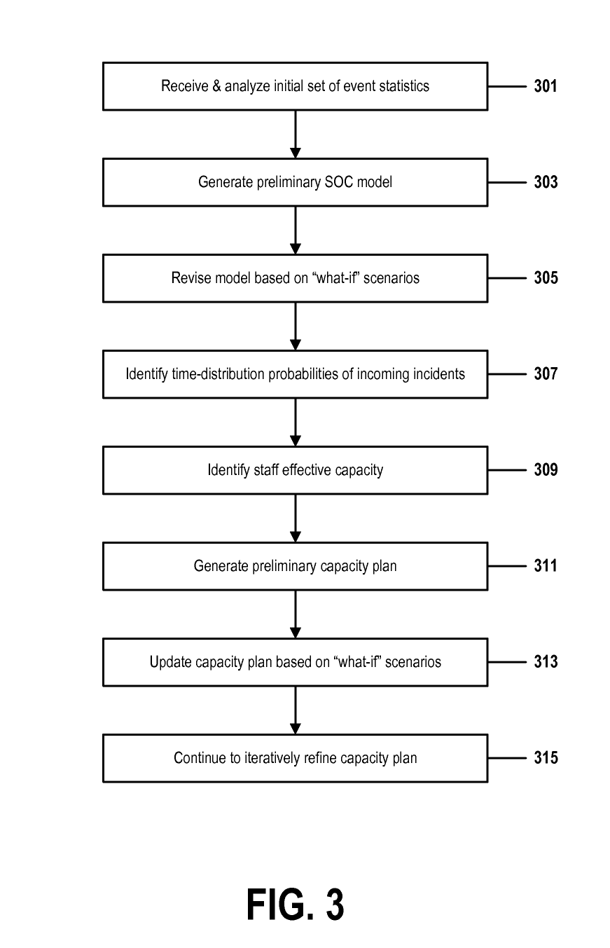

In some embodiments, and as shown in the embodiments of FIG. 3, this capacity plan may be further refined to provide interval capacity-planning information that identifies probability distributions of workloads, staffing requirements, and other resource requirements for each time interval comprised by a workday, week, month, year, or other duration of time.

FIG. 3 is a flow chart that describes detailed steps of an embodiment of a method for dynamically modeling workloads, staffing requirements, and resource requirements of a security operations center (SOC) in accordance with embodiments of the present invention. FIG. 3 comprises steps 301-315.

In step 301, a processor of a computer system receives information that may comprise a set of values of parameters that characterize an operation of an incident-handling business function such as a SOC.

In this embodiment, the received information may comprise statistics about past incidents. These statistics might, for example, be aggregated or otherwise analyzed by the processor in order to identify an incoming threat rate, wherein the threat rate identifies an average number of threats per time unit that were identified by the SOC during a past period of time.

These statistics might further allow the processor to identify a combination of:
an average threat-handling time that identifies an average duration of time that the SOC required during the past time period to evaluate and characterize an incoming threat or to place the incoming threat into a queue for subsequent resolution;
a target threat-response time that identifies a maximum duration of time that a threat should remain in the queue before resolution by the SOC; and
a required service level that may be a function of a target threat-response time. In some embodiments, a service level may be represented as a probability that an incoming threat will be resolved and removed from the queue within a threshold duration of time. This threshold duration may begin when the threat is initially identified, when the threat is initially placed in the queue, or at some other time deemed by the SOC to be relevant. In some embodiments, the service level may be represented in other ways, such as by a numeric representation of a number of threats identified or resolved within a period of time; as a fractional, decimal, or per cent representation of a number of threats identified or resolved within a period of time in relation to a total number of incoming threats; as an integer that identifies a particular service level known to those with expert knowledge of the business; or as some other type of identifier. In some embodiments, identifying a required or desired service level may, all or in part, be a function of other business information known about the SOC or of a design or implementation goal of the SOC or of an other business function.

One or more of these parameters and statistics may, as deemed necessary by the SOC, be replaced by or complemented by other parameters and statistics received in step 301, ay be identified or inferred in addition to, or instead of, one or more of the parameters and statistics received in step 301. This received information may, for example, identify a total number of threats, a frequency of threats, or an average number of threats per unit time, identified or resolved during a past period of time, where a threat or other incoming incident might comprise a quantity or frequency of incoming incidents, such as an SOC's malware detections. Such parameters might further describe goals of the SOC, such as a goal of evaluating or otherwise addressing a certain per cent of incoming incidents within a target-handling time.

In step 303, the processor performs an initial modeling procedure that generates a preliminary model of the SOC's future workload as a function of one or more of the values received in step 301. This preliminary model allows the processor to identify an initial set of staffing requirements and other resource requirements necessary to handle an identified forecast workload. In some embodiments, this generating is performed as a further function of other information provided by a user or designer who possesses business knowledge of the SOC or of an other business function, or as a further function of business information received from an other source.

In embodiments described herein, the processor uses information identified by this generating to identify and report a “traffic intensity” to a user. Traffic intensity identifies a characteristic of incoming events or threats that characterizes a volume, rate, amount, number, frequency, or other parameter by which incoming events or threats may be quantized or compared. Traffic intensity may be expressed by any means known to those skilled in the art and may be identified or derived by any means known to those skilled in the art of business science, statistical analysis, or related fields.

In the embodiment described by FIG. 3, this step comprises using an Erlang C statistical model to express traffic intensity in units of Erlangs, wherein an Erlang is a dimensionless unit of traffic density known to those skilled in the art. In embodiments described here, one Erlang unit (or “Erlang factor” unit) might represent a unit of workload that requires one unit of time of one workload server (such as an analyst or other SOC worker). In other embodiments of the present invention, one Erlang might be scaled to represent a different number of units of time of a different number of workload servers.

An Erlang C model is a traffic-modeling formula that has been used in call-center applications known to those skilled in the art to calculate delays or to predict waiting times for callers as a function of one or more of three factors:
a number of call-center workers providing service (“workload servers”);
an average number of callers waiting in queue to speak to a call-center worker; and
an average duration of time a caller waits in queue to be serviced.

In such a call-center application, the Erlang C model assumes that a queued caller remains enqueued until it can be serviced by a worker. This assumption is appropriate in operations where, if an incoming event cannot be immediately serviced, it must wait in queue until a server becomes available to address the event.

One novel aspect of embodiments of the present invention is a use of Erlang units and an adaptation of methods of the Erlang C call-center call-traffic modeling formula to model an incident-handling business function such as an SOC.

Another novel aspect of embodiments of the present invention is a development of a capacity-planning model based, not on a number of supported devices or users, but on an incoming incident rate.

Another novel aspect of embodiments of the present invention is a development of a workload model that differentiates among different statuses of incoming events. In some cases, incoming events are initially sorted by severity, for example, into potential threats, certain threats, unidentified events, or identified low-priority nonthreats. Each such category of event may be defined to generate a different workload and a workload associated with a particular event may change if the status of the event changes. If, for example, a prior event that had been classified as a certain threat early in its lifecycle is reclassified as a nonthreats, a workload associated with the threat may be adjusted to reflect the change in status.

In one embodiment of the present invention, the processor might, for example, derive a workload (in units of Erlangs or Erlang Factors) through the following procedure, based on information received in step 301. In this example, the received information might reveal that the SOC received, on average, 13 threats/hour during the past 60 days and that the SOC required an average of 10 minutes to resolve each threat. In other embodiments, this information may be represented as a function of 30-minute time units, resulting in an equivalent incoming threat rate of 6.50 threats per half-hour.

In this example, the processor would thus identify a threat workload as a traffic intensity expressed in units of Erlangs by computing:

$$\begin{matrix}Workload = [ number of threats \text{/} hr ] \times [ handling time \text{/} threat ] \\ = [ 13 threats \text{/} hr ] \times [ 10 workload \text{-} minutes \text{/} threat ] \\ = 130 workload \text{-} minutes \text{/} 60 minutes \\ = 2.17 workload \text{-} hours \text{/} hr \\ = 2.17 Erlangs\end{matrix}$$

In this example, the processor would then, in step 303, report to a user a likelihood that the business function would need to handle a workload associated with a “traffic intensity” (or equivalent term) of 2.17 Erlangs. This would mean that 2.17 hours of worker time are necessary during every one-hour duration of time in order for the SOC to provide a desired level of service when handling the workload described above.

The processor in this step might also translate this derived traffic intensity figure into a preliminary staffing requirement, based on the business function's estimate of an average worker's workload capacity. If, for example, an average SOC analyst can provide an average of 0.5 Erlangs of workload handling, it would take five such analysts to handle a 2.17-Erlang workload.

In some embodiments, this preliminary model assumes a uniform distribution of workload and capacity requirements over time. In the following steps, such a distribution will be refined to better identify time-based variations.

In step 305, the processor may allow a user to evaluate one or more ad hoc what-if scenarios by allowing the user to revise certain of the parameters inferred from the statistics received in step 301 or by allowing the user to revise certain of the results derived or identified in step 303. The processor responds to these revisions by revising the preliminary model generated in step 303 and by communicating updated “what-if scenario” information to the user based on the resulting revised model. These revisions to the model and the updated information may comprise updates to projected SOC performance and resource requirements identified or derived in step 303 that result as a function of the user's ad hoc revisions.

In one example, the processor in step 305 may let a user modify values of any combination of: an incoming threat rate, an average threat-handling time (an average time to identify and evaluate an incoming event), a target threat-response time (a maximum duration of time allocated to resolve an incoming threat), a desired level of service, or a maximum number of available analysts.

In response to this modifying by the user, the processor would then revise its preliminary model, or its most recently revised version of the preliminary model, in order to identify how the SOC model would operate under the revised conditions or constraints.

In this case, the processor might then display revised values of parameters that comprise:

a traffic intensity (in Erlangs);
a % utilization of each analyst required to meet a desired service level;
a % probability that an incoming incident will wait in a queue to be serviced;
a % probability that an incoming incident may be serviced without enqueuing;
an average queue wait time; or
a % probability that an incident will be resolved within a target handling time.

In some embodiments, additional parameters or different parameters might be revised or displayed. In some embodiments, a warning might be displayed if a certain implementation-dependent condition is met or if a revision gives rise to an irreconcilable conflict. Such a condition or conflict might, for example, arise from a revised model's inability of an available number of available analysts to deliver a desired service level, given an expected traffic intensity.

Each time a user revises a parameter, the processor in step 305 may respond by revising its model and communicating to the user resulting updated values, thus allowing the user to evaluate an effect of the user's revision. In one example, a user might use this tool to identify a greatest threat-response time necessary in order to allow a particular number of available analysts to provide a desired level of service when handling a particular workload. The user might iteratively perform such an identification by entering a succession of different threat-response time values, while holding constant a number of available analysts and a projected workload, until the processor reports that an entered threat-response time value does not create an irreconcilable conflict.

At the conclusion of step 305, the processor will have refined its workload model, using a method based on an Erlang C formula, and will have communicated to the user refined values of parameters that characterize a workload and that further characterize an operation of the SOC associated with the SOC's ability to provide a desired level of service. This refined model may comprise, among other parameters: a revised value of traffic intensity that characterizes an expected workload; and a revised staffing requirement that specifies an average number of analysts or other SOC employees needed to provide a desired level of service when handling the revised traffic intensity.

In step 307, these time-averaged results are further refined by developing a statistical probability distribution that more precisely identifies how incoming threats are likely to be vary throughout a workday. Any statistical method known to those skilled in the art may be used to perform this task, but embodiments described herein use a Poisson distribution.

As is known by those skilled in the art of statistical analysis, a Poisson distribution may be used to model a probability of a distribution of a set of values of a variable X as a function of a mean value of the set of values. If, for example, values of variable X vary between 0.0 and 10.0 over the course of a day, a Poisson distribution would identify a probability that a mean value of X assumes a particular value between 0.0 and 10.0 during each hour, half-hour, minute, or other unit of time comprised by that day. Such a distribution might, for example, identify a 1% probability that a mean value of X would equal 1.0 during a period from 1:00 PM to 2:00 PM, a 5% probability that a mean value of X would equal 2.0 during a period from 3:45 AM to 4:00 AM, or a 7% probability that a mean value of X would equal 0.75 during a period from 10:00 AM to 10:00 PM.

In embodiments described by FIG. 3, the processor in step 307 uses a Poisson Distribution function to refine the model generated in steps 301-305. This refinement increases the precision of the time-averaged uniform distribution of incoming incidents identified in the earlier steps by generating a set of probabilities each identify a probability that a mean number of incidents may assume a particular value during a particular subset of a work day, work week, or other time period.

In one example, this step may determine a distinct set of probabilities for each 30-minute period of a typical workday, wherein each probability of the set of probabilities identifies a probability that a particular number of incoming threats will arrive during that time period. The result may be a set of distribution curves, one for each time period of the SOC's workday, where each curve represents a set of probabilities that different numbers of threats might arrive during a particular time period. Other embodiments may generate a set of distribution curves, one for each possible number of incoming threats, where each curve represent a set of probabilities that a particular number of threats will arrive during each time period of the SOC's workday. In some cases, these curves may each be associated with a range of numbers of threats.

In some embodiments, using methods known to those skilled in the art, a standard deviation of each Poisson distribution may be used here or in step 311 to distinguish staffing requirements needed when a business function requires a lead capacity-planning strategy (in which extra analysts are staffed with the goal that at least one analyst is always available to immediately handle an incoming threat), a match capacity-planning strategy (in which analysts are staffed with the goal that the number of available analysts being is close as possible to the minimum number required to handle an expected number of incoming threats as the threats arrive), or a lag capacity-planning strategy (in which analysts are staffed with the goal that incoming threats may be placed in a queue and handled by analysts within a specified period of time).

In such cases, a lead strategy may set staffing requirements such that the SOC is more likely to always have more capacity than is needed, and a lag strategy may set staffing requirements such that the SOC is allowed to sometimes have fewer resources than needed, so long as it has the ability to add resources when necessary. In one example, a business decision to implement a lead strategy may be result in setting staffing levels high enough to handle incoming threat distributions that lie within several standard deviations of a mean distribution.

At the conclusion of step 307, the processor will have refined its model of the SOC sufficient to answer a broad range of questions, such as:
What is the probability that the SOC will receive 5-7 threats during a daily time period between 1:00 PM and 2:00 PM?
During how many 30-minute intervals of a typical workday is the SOC likely, within 1.0 standard deviation, to receive 6 or more threats? or
Given a projected daily mean of 6.5 threats received per 30-minute period over the course of a standard work day, what is the standard deviation of this daily distribution?

In step 309, the processor receives information related to previous staff-availability figures of the SOC. The processor uses this information to refine a 2080 hours/year rough estimate of the number of hours/year that a SOC worker is available to work on the modeled workload.

Such information may include historical productivity figures, calendar schedules, and break schedules. It may, for example, comprise an average number of minutes per day, week, month, or year spent by a worker on meals, administrative time, training time, vacation time, sick time, or other related activities.

This information may be entered interactively by a user, read from stored data entered by a user, culled from system logs, statistics, employee records, or other automatically gathered information, or from any other information source known to those familiar with the business or skilled in the art of information technology.

At the conclusion of step 309, the processor will have identified an estimated amount of time that a work will be available to work during an hour, day, week, month, year, or other time period. Such information may be used in creating a capacity play by allowing the processor to infer staff availability as a function of an average worker's effective work capacity.

In step 311, the processor develops a preliminary capacity plan as a function of the information received, inferred, or derived in steps 301-309. This preliminary plan may take the form of an interval model that identifies distinct staffing requirements for each work-time interval of the SOC's typical workday.

This preliminary capacity plan may be developed as a function of a decision of whether the capacity plan should be based on a lead, match, or lag capacity-planning strategy and on a choice of how great a lead or lag would best fit the needs of the SOC. In some embodiments, this decision may be based on a goal of the business or of the business function, or on a result of a needs analysis, as a function of methods known to those skilled in the art. This needs analysis may be based on real-world data that describes prior operations of the business or of the business function.

In some embodiments, the capacity plan may be developed as a function of standard deviations of the Poisson distributions of step 307, using statistical methods known to those skilled in the art, or as described above in the description of step 307.

In step 311, the processor may make other adjustments to the preliminary plan that, in embodiments, may comprise:
adjusting the interval period to better match the business function's scheduling periods. If, for example, analysts are scheduled in half-hour blocks, the capacity plan may be adjusted from 60-minute to 30-minute units;
adjusting the capacity plan to compensate for hours during which the business function does not operate. If, for example, an SOC is open only eight hours a day, a capacity plan that accounts for 7×24 operation might be adjusted to address an hourly incoming threat rate that is triple the hourly rate of a 24-hour plan; or
adjusting the capacity plan to compensate for days during which the business function does not operate. If, for example, an SOC is open only on weekdays, a capacity plan that accounts for 7×24 operation might be adjusted to address an hourly incoming threat rate that is 40% greater than (that is, 7/5 of) the hourly rate of a 24-hour plan.

Other adjustments, such as user-entered adjustments average staff effective availability may be further accounted for by the processor in this step.

At the completion of step 311, the processor will thus have generated interval plan by adjusting the results of the Poisson distribution with business-specific staff-availability and facility-availability adjustments culled from user inputs, from expert business knowledge of system designers, and from statistical records gathered in this step or in step 301.

The resulting interval-based capacity plan will specify, for each interval of a selected time period, a number of analysts required to provide a desired service level, which may include an estimated queue time or backlog, given a specific projected workload, average threat response-handling time, effective staff availability, traffic intensity, or other parameters discussed above or identified by the business function as relevant to estimating staffing requirements.

In step 313, the processor communicates a resource-planning table to the user, wherein this table is a representation of information identified in step 311. As in step 305, this table allows the user to evaluate what-if scenarios in order to identify optimal planning parameters. Unlike the procedure of step 305, however, step 311 allows a user to entire different values of adjustable parameters for individual time periods.

In this step, for example, a user might be aware of a trend, not evident from the information received in step 301, that threats tend to spike toward the middle of a workday. The user might then enter values into a displayed resource-planning table that increase existing incoming threat-rate values for the time periods that span 11:00 AM through 1:00 PM. In response to this entering, the processor will revise its existing models and capacity plan, as derived in steps described above, and then redisplay updated values of the resource-planning table.

In some embodiments, if a conflict or other undesirable condition occurs as a result of this updating, the processor may visually flag values associated with that conflict or condition. If, for example, the manually entered increased threat rates result in an inability to attain a desired level of service with a specified number of available analysts, cells of the table that identify this inability might be displayed in red.

In other embodiments, users might be allowed to vary other parameters, such as values of workloads, service levels, available staffing levels, or other parameters described above or deemed relevant by those with expert knowledge.

In some embodiments, the processor may compute and communicate to the user other parameters associated with the business-function model's ability to address its workload. These other parameters might include ratios of other characteristics of the modeled business function, such as a ratio of staffing coverage to cost that compares effectiveness of distributing total hours of analyst availability (where staffing cost is a function of the total number of hours) differently across the time intervals of the interval model. In other embodiments, for example, the results of what-if analyses may allow the user to identify an optimal number of hours per day or days per week that the business function should be operational.

In some embodiments, this information may be used to further compute cumulative backlogs of a capacity plan, which occur because of the persistence of incoming incidents. In other words, if a capacity plan comprises resource insufficient to handle 100% of a business function's workload, the unaddressed portion of the workload will not be resolved over time. Instead, it will continue to accumulate until the business function's resources are increased sufficiently to handle the additional workload created by the backlog.

As in step 305, at the conclusion of step 311, the processor will have developed and communicated a capacity plan that has been refined by the user as a function of the user's expert knowledge of the business or of the business function.

In step 315, the refined final capacity plan is iteratively refined through repetition of all or a subset of steps 301-315.

What is claimed is:

1. A method for dynamically modeling workloads, staffing requirements, and resource requirements of a security operations center, the method comprising:
a processor of a computer system receiving an initial set of values of a set of parameters, wherein the set of parameters characterize a workload of the security operations center and a target level of service intended to be provided by the center, and wherein the workload comprises one or more tasks associated with resolving a set of incoming incidents;
the processor deriving a preliminary model of the security operations center as a function of the received values;
the processor communicating one or more characteristics of the preliminary model to a user;
the processor further receiving from the user a first updated value in response to the communicating;
the processor revising the preliminary model as a function of the first updated value;
the processor employing a statistical method to translate the revised preliminary model into a preliminary interval model that comprises a set of distribution curves, wherein a first curve of the set of distribution curves comprises a first set of probabilities associated with a first time interval of a set of time intervals, and wherein a first probability of the first set of probabilities identifies a probability that a first quantity of incoming incidents of the set of incoming incidents will be received by the security operations center during the first time interval;
the processor accessing staff-availability information;
the processor incorporating the staff-availability information into the preliminary interval model in order to produce a preliminary capacity plan that identifies resource requirements and staff requirements for each time interval of the set of time intervals;
the processor further communicating to the user the preliminary capacity plan as a user-editable preliminary resource-planning table;
the processor accepting from the user a second updated value, wherein the user has entered the second updated value by editing the preliminary resource-planning table;
the processor generating a refined capacity plan as a function of the accepting.

2. The method of claim 1, wherein the workload is a function of an average incoming incident rate at which the center receives incoming incidents and is a further function of an average incident-resolution time that identifies an average amount of worker time needed to resolve a received incident.

3. The method of claim 2, wherein the target level of service comprises a goal of responding to a certain portion of the workload within a target incident response time, and wherein the target incident response time identifies a maximum acceptable duration of time between a first time at which the center receives a first incident of the set of incoming incidents and a second time at which the center responds to the first incident.

4. The method of claim 3, further comprising the processor prioritizing the first incident as a function of a severity of the first incident, wherein the target incident response time is a function of the prioritizing.

5. The method of claim 3, wherein the preliminary model identifies an average number of required incident handlers needed to provide the target level of service when the center services the workload.

6. The method of claim 1, wherein the communicating one or more characteristics of the preliminary model comprises communicating a traffic intensity and an average number of required incident handlers needed to provide the target level of service when the center services the workload, and wherein the traffic intensity quantifies the workload in units of Erlangs.

7. The method of claim 5, wherein the first updated value is selecting from a group comprising: a first updated average incoming incident rate, a first updated average incident-resolution time, a first updated target incident response time, an updated target level of service, and a first updated average number of required incident handlers.

8. The method of claim 7, wherein the statistical method comprises using a Poisson Distribution to generate time-distributed probabilities of values of the average incoming incident rate.

9. The method of claim 8, wherein a capacity-planning strategy is selected as a function a standard deviation of the Poisson Distribution, and wherein the capacity-planning strategy is chosen from a group comprising a lead strategy, a lag strategy, and a match strategy.

10. The method of claim 1, wherein the staff-availability information is selected from a group comprising: an average daily staff break time, an average daily staff administrative time, an average daily staff training time, a listing of annual work holidays, an average daily staff sick time, an average staff vacation time, and a listing of security operations center operating hours.

11. The method of claim 9, wherein the second updated value is selecting from a group comprising: a second updated average incoming incident rate, an updated capacity-planning strategy, an updated duration of an interval of the set of time intervals, a second updated average incident-resolution time, a second updated target incident response time, an updated daily shift starting time, an updated daily shift ending time, an updated average number of incoming incidents per time interval during a period between the updated daily shift starting time and the updated daily shift ending time, and an updated target level of service.

12. The method of claim 1, further comprising providing at least one support service for at least one of creating, integrating, hosting, maintaining, and deploying computer-readable program code in the computer system, wherein the computer-readable program code in combination with the computer system is configured to implement the receiving, deriving, communicating, further receiving, revising, employing, accessing, incorporating, further communicating, accepting, and generating.

13. A computer program product, comprising a computer-readable hardware storage device having a computer-readable program code stored therein, said program code configured to be executed by a processor of a computer system to implement a method for dynamically modeling workloads, staffing requirements, and resource requirements of a security operations center, the method comprising:
the processor receiving an initial set of values of a set of parameters, wherein the set of parameters characterize a workload of the security operations center and a target level of service intended to be provided by the center, and wherein the workload comprises one or more tasks associated with resolving a set of incoming incidents;
the processor deriving a preliminary model of the security operations center as a function of the received values;
the processor communicating one or more characteristics of the preliminary model to a user;
the processor further receiving from the user a first updated value in response to the communicating;
the processor revising the preliminary model as a function of the first updated value;
the processor employing a statistical method to translate the revised preliminary model into a preliminary interval model that comprises a set of distribution curves, wherein a first curve of the set of distribution curves comprises a first set of probabilities associated with a first time interval of a set of time intervals, and wherein a first probability of the first set of probabilities identifies a probability that a first quantity of incoming incidents of the set of incoming incidents will be received by the security operations center during the first time interval;
the processor accessing staff-availability information;
the processor incorporating the staff-availability information into the preliminary interval model in order to produce a preliminary capacity plan that identifies resource requirements and staff requirements for each time interval of the set of time intervals;
the processor further communicating to the user the preliminary capacity plan as a user-editable preliminary resource-planning table;
the processor accepting from the user a second updated value, wherein the user has entered the second updated value by editing the preliminary resource-planning table;
the processor generating a refined capacity plan as a function of the accepting.

14. The computer program product of claim 13, wherein the workload is a function of an average incoming incident rate at which the center receives incoming incidents and is a further function of an average incident-resolution time that identifies an average amount of worker time needed to resolve a received incident.

15. The computer program product of claim 14, wherein the target level of service comprises a goal of responding to a certain portion of the workload within a target incident response time, and wherein the target incident response time identifies a maximum acceptable duration of time between a first time at which the center receives a first incident of the set of incoming incidents and a second time at which the center responds to the first incident.

16. The computer program product of claim 13, wherein the communicating one or more values of a set of characteristics of the preliminary model comprises communicating a traffic intensity and an average number of required incident handlers needed to provide the target level of service when the center services the workload, and wherein the traffic intensity quantifies the workload in units of Erlangs.

17. The computer program product of claim 13, wherein the statistical method comprises using a Poisson Distribution to generate time-distributed probabilities of values of the average incoming incident rate, wherein a capacity-planning strategy is selected as a function of a standard deviation of the Poisson Distribution, and wherein the capacity-planning strategy is chosen from a group comprising a lead strategy, a lag strategy, and a match strategy.

18. A computer system comprising a processor, a memory coupled to said processor, and a computer-readable hardware storage device coupled to said processor, said storage device containing program code configured to be run by said processor via the memory to implement a method for dynamically modeling workloads, staffing requirements, and resource requirements of a security operations center, the method comprising:
the processor receiving an initial set of values of a set of parameters, wherein the set of parameters characterize a workload of the security operations center and a target level of service intended to be provided by the center;
the processor using a plurality of modeling techniques to derive a preliminary model of the security operations center as a function of the received values;
the processor communicating one or more values of a set of characteristics of the preliminary model to a user;
the processor further receiving from the user a first updated value in response to the communicating;
the processor revising the preliminary model as a function of the first updated value;
the processor accessing staff-availability information;
the processor employing a statistical method to translate the revised preliminary model into a preliminary interval model that comprises a set of distribution curves, wherein a first curve of the set of distribution curves comprises a first set of probabilities associated with a first time interval of a set of time intervals, and wherein a first probability of the first set of probabilities identifies a probability that a first number of incoming incidents will be received by the security operations center during the first time interval;
the processor incorporating the staff-availability information into the preliminary interval model in order to produce a preliminary resource-planning table that identifies resource requirements and staff requirements for each time interval of the set of time intervals;
the processor further communicating to the user the preliminary resource-planning table;
the processor accepting from the user a second updated value in response to the further communicating;
the processor generating a capacity plan that identifies resource requirements and staff requirements for each time interval of the set of time intervals, wherein the identified resource requirements and staff requirements are identified as a function of the accepting.

19. The computer system of claim 18, wherein the workload is a function of an average incoming incident rate at which the center receives incoming incidents and is a further function of an average incident-resolution time that identifies an average amount of worker time needed to resolve a received incident.

20. The computer system of claim 18, wherein the statistical method comprises using a Poisson Distribution to generate time-distributed probabilities of values of the average incoming incident rate, wherein a capacity-planning strategy is selected as a function of a standard deviation of the Poisson Distribution, and wherein the capacity-planning strategy is chosen from a group comprising a lead strategy, a lag strategy, and a match strategy.
